(19) United States
(12) Patent Application Publication
(10) Pub. No.: US 2026/0217405 A1
(43) Pub. Date: Jul. 30, 2026

(54) DEVICE FOR ADJUSTING A SPACING BETWEEN CONTAINERS

(71) Applicant: Syntegon Technology GmbH, Stuttgart (DE)

(72) Inventors: Tobias Trittner, Schwäbisch Hall (DE); Martin Burkhardt, Feuchtwangen (DE); Stefan Knausenberger, Steinsfeld (DE)

(21) Appl. No.: 19/453,051

(22) Filed: Jan. 20, 2026

(30) Foreign Application Priority Data
Jan. 30, 2025 (DE) 10 2025 103 512.1

(51) Int. Cl. B65B 35/18; B65B 3/00; B65B 5/06; B65B 35/02; B65B 57/00; B65G 47/31; B67C 3/00; B67C 3/24

(52) U.S. Cl. CPC B65B 35/18; B65B 3/006; B65B 5/06; B65B 35/02; B65B 57/00; B65G 47/31; B67C 3/007; B67C 3/24; B65G 2201/0235

(57) ABSTRACT

A device for adjusting a spacing between containers, preferably vials and/or carpules and/or syringes, having a dispensing holder having at least two first container receptacles that are arranged with an invariable first mutual spacing (D1) and are each configured to hold one of the containers, further having a receiving holder having at least two second container receptacles that are arranged with an invariable second mutual spacing (D2) that differs from the first spacing (D1) and are each configured to hold one of the containers. A passive transfer element is provided, which is independent of the dispensing holder and the receiving holder and by which a transfer of the containers from the first container receptacles to the second container receptacles can be effected. The device has a drive system that is configured to generate a linear relative movement between the dispensing holder, the receiving holder and the passive transfer element.

### BACKGROUND

The invention relates to a device for adjusting a spacing between containers, to a filling machine having such a device and to a method for operating such a device.

Containers that are intended in particular for filling with pharmaceutical products, such as, for example, vials, carpules and syringes, are usually provided at the filling machine intended for filling and, if necessary, closing the containers, in specially designed packagings, such as, for example, tubs or trays. In these packagings, the containers are typically arranged with a small mutual spacing, which is specific to the packaging, to enable as many containers as possible to be accommodated in a single packaging. Such a spacing specific to the packaging may depend on the respective type of packaging.

For processing on the filling machine, it is usually necessary to adjust the spacing between the containers to a machine-specific spacing, also known as a machine-specific separation. To enable optimum filling and closing of the containers, a machine-specific spacing that is greater than the spacing specific to the packaging material is usually required at the filling and/or closing station of the filling machine. It is therefore necessary in particular to adjust the spacing between the containers before the containers can be supplied to the filling and/or closing station. The adjustment of the spacing between the containers may have a ratio, for example, of between 1:1 and 1:7. To enable a high output rate, it is desirable to adjust the spacing between a large number of containers within a machine cycle. At the same time, items must be transported in a gentle manner.

Various devices for adjusting the spacing between containers are known from the prior art.

For example, adjustment of the spacing is effected by means of a conveyor screw, with the change in spacing being determined by the pitch of the conveyor screw. Such a conveyor screw offers little flexibility for creating different spacings. In addition, the items are exposed to high levels of friction and can possibly become scratched.

Also known is a device having so-called movers, in which each container is placed individually in one of the movers and then moved independently of other containers. The movers are wide in relation to the containers, such that, for small spacings specific to the packaging material, it is necessary to use a plurality of devices, having movers, positioned parallel over one other. Disadvantages are the high costs of such a device and the comparatively high space requirement, which makes a compact layout of the filling machine more difficult.

Additionally known, from DE 102020134783 A1, is a device that has a scissor mechanism. In such a device, the containers are arranged in individual receiving units and then moved by means of the scissor mechanism and spread apart from one another in order to alter the spacing between the receiving units. Such a device requires a lot of installation space and is of a comparatively high weight. With this solution, compared to the spacing specific to the packaging, a large machine-specific spacing requires the individual receiving units to have a correspondingly large travel path.

### SUMMARY

Proceeding from this, it is an object of the present invention to at least partially solve the problems described with reference to the prior art and, in particular, to specify a device and a method by which it is possible to adjust a spacing between containers in a simple and cost-effective manner.

This problem is achieved with a device, a filling machine and a method according to the features of the disclosure. Further advantageous designs are given in the description and in particular also in the description of the figures. It is to be noted that a person skilled in the art may combine individual features with one another in a technologically meaningful way and thus obtain further designs of the invention.

To be described here is a device for adjusting a spacing between containers, preferably vials and/or carpules and/or syringes, having a dispensing holder comprising at least two first container receptacles that are arranged with an invariable first mutual spacing and are each configured to hold one of the containers, further having a receiving holder comprising at least two second container receptacles that are arranged with an invariable second mutual spacing that differs from the first spacing and are each configured to hold one of the containers, further having a passive transfer element, which is independent of the dispensing holder and the receiving holder and by means of which a transfer of the containers from the first container receptacles to the second container receptacles can be effected, the device having a drive system that is configured to generate a linear relative movement between the dispensing holder, the receiving holder and the passive transfer element.

The dispensing holder may also be referred to as a slider and, in particular, has a body to which, or in which, respectively, the at least two first container receptacles are attached, or inserted. The body may be solid or, in addition to the first container receptacles, have recesses for weight reduction, for example. The dispensing holder may be realized in one or more parts. The at least two first container receptacles are arranged with an invariable first spacing that corresponds, in particular, to a packaging-specific spacing. The dispensing holder may have more than two first container receptacles that, in particular, are arranged in a regular row, i.e. each with the same invariable first mutual spacing. The first container receptacles are preferably each designed in such a way that the containers can be dispensed laterally, i.e. orthogonally with respect to a first container axis that extends along the at least two first container receptacles, or along which the containers can be arranged in the first container receptacles. In particular, the first container receptacles are U-shaped, resulting in a lateral opening through which the containers can be dispensed. The first container receptacles may have one or more offsets.

The receiving holder may also be referred to as a receiver or receptacle carrier and, in particular, has a body to which, or in which, respectively, the at least two second container receptacles are attached, or inserted. The body may be solid or, in addition to the second container receptacles, have recesses for weight reduction, for example. The receiving holder may be realized in one or more parts. The at least two second container receptacles are arranged with an invariable second spacing that corresponds, in particular, to a machine-specific spacing. The receiving holder may have more than two second container receptacles that, in particular, are arranged in a regular row, i.e. each with the same invariable second mutual spacing. The second container receptacles are preferably each designed in such a way that the containers can be received laterally, i.e. orthogonally with respect to a second container axis that extends along the at least two second container receptacles, or along which the containers can be arranged in the second container receptacles. In particular, the second container receptacles are U-shaped, resulting in a lateral opening through which the containers can be received. The second container receptacles preferably have a chamfer on, or in, the region of the lateral opening to facilitate transfer. The second container receptacles may have one or more offsets.

Invariable spacing means that — unlike the solution with the scissor mechanism known from the prior art — there is no adjustment of the spacing between the containers on the dispensing holder or the receiving holder.

Preferably, the first container receptacles are configured to hold the containers at a respective first container portion, and the second container receptacles are configured to hold the containers at a respective second container portion that is different from the first container portion. For example, it may be provided that the containers are held at their container neck by the first container receptacles and at their container body by the second container receptacles, or vice versa.

The passive transfer element, also referred to as a baffle, is independent of the dispensing holder and the receiving holder. The passive transfer element — unlike the known scissor mechanism — is not directly connected to the dispensing holder or the receiving holder. Passive means that the transfer element has a rigid body and is in any case not a means that is comparable to the known scissor mechanism and its individually movable receiving units. The passive transfer element may be realized in one or more parts and, in addition to the preferably plate-shaped body, may comprise a fastening structure to which the body can be fastened, for example by means of screws. Such a design allows the passive transfer element to be easily adapted to different container types or sizes, for example by the provision of bodies of differing thicknesses. The body of the passive transfer element may be solid or, for example, have recesses to reduce weight. The passive transfer element, or its body, is preferably produced from a material that is softer than the material of the containers, which are usually made of glass. For example, the passive transfer element may be made of a plastic.

In the present case, transfer (or also, transferring) means that the respective container is in continuous contact with at least one of the first container receptacle and the second container receptacle. The dispensing holder, in particular the first container receptacles, and the receiving holder, in particular the second container receptacles, are realized accordingly for this purpose and can be arranged relative to each other for transfer. Transfer is preferably effected by the containers initially coming to bear against the passive transfer element and bearing against the passive transfer element during the transfer. During the transfer of a container, a first container receptacle is arranged opposite a second container receptacle, such that they are brought into alignment with each other. The dispensing holder and the receiving holder are preferably arranged at a distance from each other during the transfer in such a way that there is as small a gap as possible between the dispensing holder and the receiving holder. As viewed from above, it is possible for parts, or portions, of the dispensing holder and the receiving holder to overlap.

Transfer is made possible by the linear relative movement between the dispensing holder, the receiving holder and the passive transfer element. Linear relative movement means that the dispensing holder, the receiving holder and the passive transfer element can be moved linearly relative to each other. A radial relative movement may in principle be provided on the device according to the invention, but is not required for the transfer of the containers. The dispensing holder, the receiving holder and the passive transfer element can be moved linearly relative to each other in particular in such a way that the containers can be transferred individually one after the other.

It is preferred if between the dispensing holder, the receiving holder and the passive transfer element, at least two different linear relative movements can be generated along a first movement path and a second movement path.

It is particularly preferred if the first movement path and the second movement path are collinear.

The first movement path and the second movement path, or the different relative movements, are preferably parallel or antiparallel.

The relative movements are preferably generated by the movement of at least two of the three components dispensing holder, receiving holder and transfer element, the third component being arranged in a fixed position.

The drive system comprises at least one linear drive. Preferably, at least two linear drives are provided. The drive system may have a transmission. In particular, the drive system has an electric power supply for the at least one linear drive. The at least two linear drives are preferably each designed to move one of the three components dispensing holder, receiving holder and transfer element in order thereby to generate a total of two linear relative movements between the three components dispensing holder, receiving holder and transfer element.

The device can be used for different container types and sizes, preferably vials, carpules and/or syringes. However, other container types and sizes are also conceivable.

With the device according to the invention, a high degree of flexibility is possible, both on the supply side for the packagings that can be processed and on the discharge side for the machine-specific spacings that can be produced. The installation space required for the device according to the invention is not dependent of the machine-specific spacing that can be produced. In addition, a high output rate is possible with the device according to the invention. The device according to the invention offers the possibility of adjusting the spacing between the containers, also referred to as the separation, flexibly and in particular irrespective of the ratio of the adjustment. It is also possible to realize transport of items that is as gentle as possible, without glass-to-glass contact.

In a preferred embodiment variant, the passive transfer element is arranged in a fixed position, and the dispensing holder and the receiving holder are realized so as to be movable independently of each other.

In the present case, in a fixed position is understood to mean that the passive transfer element is not moved, or does not have to be moved, in order to effect the transfer of the containers.

The dispensing holder is realized so as to be movable relative to the passive transfer element and the receiving holder. In particular, the dispensing holder can be moved relative to the passive transfer element in order to dispense the containers from the dispensing holder.

The receiving holder, in turn, is realized so as to be movable relative to the passive transfer element and the dispensing holder. In particular, the receiving holder can be moved relative to the passive transfer element in order to receive the containers in the receiving holder, and thus enable transfer. In particular, the receiving holder can furthermore be moved relative to the dispensing holder in order to bridge a difference between the first spacing and the second spacing (also referred to as a separation discontinuity), and to bring a first container receptacle into alignment with a second container receptacle. In this regard, it may be provided that one or more first container receptacle(s) or one or more second container receptacle(s) is/are to be skipped because they are empty or are to remain empty.

Movable independently of one another means that a movement of the dispensing holder does not necessarily cause a movement of the receiving holder and vice versa, although this may be provided.

In particular, the dispensing holder is moved by a first linear drive of the drive system. In particular, the receiving holder is moved by a second linear drive of the drive system. During their movement, the dispensing holder and/or the receiving holder may be guided, for example by a rail.

Preferably, the dispensing holder can be moved along a first movement path, with the first movement path running substantially parallel to the second container axis. The receiving holder can preferably be moved along a second movement path, the second movement path running substantially parallel to the first container axis. Preferably, the first movement path runs parallel to the second movement path. The first container receptacles are preferably each realized in such a way that the containers can be dispensed orthogonally with respect to the first movement path. The second container receptacles are preferably each realized in such a way that the containers can be received orthogonally with respect to the second movement path.

Particularly advantageously, it is provided that the drive system has a control unit that is configured to control the dispensing holder and the receiving holder in such a way that they move at mutually differing speeds.

In particular, the control unit is designed to send control commands to the at least one linear drive in order to move the dispensing holder and/or receiving holder at the respectively intended speed. The control unit is connected to the at least one linear drive, preferably via a signal connection.

The mutually differing speeds at which the dispensing holder and the receiving holder move, as well as the respective relative speed with respect to the passive transfer element arranged in a fixed position, are important for the accuracy of the transfer of the containers from the dispensing holder to the receiving holder.

The difference between the speed of the dispensing holder and the speed of the receiving holder may be such that it can be used to bridge the difference between the first spacing and the second spacing in order to bring a first container receptacle into alignment with a second container receptacle, and also to enable the respective container to be transferred smoothly. Provided on the second container receptacle, or its lateral opening, there is a chamfer, which takes into account that the first container receptacle and the second container receptacle cannot yet be exactly in alignment at the start of the transfer.

Alternatively, it may be provided the receiving holder and/or the dispensing holder is/are be controlled in such a way that they move at two different speeds. The receiving holder or the dispensing holder may then be moved, for example between two transfers of containers, in order to bridge the difference between the first spacing and the second spacing and to bring a first receiving position and a second receiving position into alignment at a speed that is different from the speed during the transfer, and that is preferably greater.

Alternatively, the difference between the first spacing and the second spacing may be bridged by stopping the dispensing holder or the receiving holder and continuing to move the respectively other of the dispensing holder and receiving holder, in particular at the same speed as during the transfer. For a transfer, the speed of the dispensing holder may be almost the same as the speed of the receiving holder. During the transfer, the dispensing holder and the receiving holder are preferably moved synchronously. In each case, the speed is in a range in which the containers can be transferred as gently as possible.

In a further preferred embodiment variant, the dispensing holder or the receiving holder is arranged in a fixed position, and the passive transfer element, as well as the respectively other of the dispensing holder and receiving holder, are realized so as to be movable independently of each other.

The design features of the embodiment variant having the passive transfer element in a fixed position are applicable and transferable to this embodiment variant, provided they are not contradictory in respect of the design features described below.

It may be provided that the receiving holder is arranged in a fixed position and the passive transfer element and the dispensing holder are realized so as to be movable. Alternatively, it may be provided that the dispensing holder is arranged in a fixed position and the passive transfer element and the receiving holder are realized so as to be movable. Whether the dispensing holder or the receiving holder is arranged in a fixed position may depend, for example, on the installation space available for the device. Here, also, in a fixed position is understood to mean that the dispensing holder, or the receiving holder, is not moved, or does not have to be moved, in order to effect the transfer of the containers.

If the receiving holder is arranged in a fixed position, the dispensing holder is movable relative to the passive transfer element and the receiving holder. In particular, the dispensing holder can be moved relative to the receiving holder in order to bridge the difference between the first spacing and the second spacing and to bring a first receiving position and a second receiving position into alignment. The passive transfer element, in turn, is movable relative to the receiving holder and the dispensing holder. In particular, the passive transfer element can be moved relative to the dispensing holder in order to dispense the containers from the dispensing holder. It may be provided that the passive transfer element and the dispensing holder are moved in mutually opposite directions. Movable independently of each other means that a movement of the dispensing holder does not necessarily cause a movement of the passive transfer element and vice versa, although this may be provided.

If the dispensing holder is arranged in a fixed position, the receiving holder is movable relative to the passive transfer element and the dispensing holder. In particular, the receiving holder can be moved relative to the dispensing holder in order to bridge the difference between the first spacing and the second spacing and to bring a first receiving position and a second receiving position into alignment. The passive transfer element, in turn, can be moved relative to the receiving holder and the dispensing holder. In particular, the passive transfer element can be moved relative to the dispensing holder in order to dispense the containers from the dispensing holder. It may be provided that the passive transfer element and the receiving holder are moved in mutually opposite directions. Movable independently of one another means that a movement of the receiving holder does not necessarily cause a movement of the passive transfer element and vice versa, although this may be provided.

In particular, the passive transfer element is moved by a third linear drive of the drive system. Preferably, the fastening structure of the passive transfer element described above is connected to the linear drive. The passive transfer element may be guided during its movement, for example by a rail.

Preferably, the passive transfer element is movable along a third movement path, the third movement path running in particular substantially parallel to the first container axis and/or the second container axis. Preferably, the third movement path runs parallel to the first movement path and/or the second movement path.

Also conceivable, of course, is an embodiment of the device in which the passive transfer element, the dispensing holder and the receiving holder are realized so as to be movable independently of one another.

Particularly advantageously, it is provided that the drive system has a control unit that is configured to control the transfer element and the dispensing holder, or the receiving holder, in such a way that they move at mutually differing speeds.

In particular, the control unit is designed to send control commands to the at least one linear drive in order to move the passive transfer element at the intended speed. For this purpose, the control unit is connected to the at least one linear drive, preferably via a signal connection.

If the receiving holder is in a fixed position, the control unit may control the passive transfer element in particular in such a way that its speed differs from that of the dispensing holder. As described above, the dispensing holder and the passive transfer element may alternatively or additionally be controlled in such a way that they move in opposite directions. In particular, the dispensing holder and the passive transfer element may be moved at mutually differing speeds in order to effect a transfer of a container. It may be provided that the passive transfer element and/or the dispensing holder is/are controlled in such a way that it/they move at two differing speeds. Thus, as already described above, the difference between the first spacing and the second spacing can be bridged at a speed that differs from the speed at which the transfer is effected.

If the dispensing holder is in a fixed position, the control unit may control the passive transfer element in particular in such a way that its speed differs from that of the receiving holder. As described above, the receiving holder and the passive transfer element may alternatively or additionally be controlled in such a way that they move in opposite directions. In particular, in order to bridge the difference between the first spacing and the second spacing, the passive transfer element, for the purpose of effecting the transfer, may move at a speed that differs from the speed at which the receiving holders move. It may be provided that the passive transfer element and/or the receiving holder is/are controlled in such a way that it/they move(s) at two differing speeds. Thus, as already described above, the difference between the first spacing and the second spacing can be bridged at a speed that differs from the speed at which the transfer is effected.

In a preferred embodiment variant, the passive transfer element has a ramp-shaped portion by means of which the transfer of the containers can be effected.

The ramp-shaped portion is arranged in particular on an end face of the passive transfer element, preferably its body, that faces towards the receiving holder, or its second movement path. The ramp-shaped portion is located in particular between two further portions that extend substantially parallel to one another and preferably substantially parallel to the first movement path and/or to the second movement path. The passive transfer element, in particular its end face, preferably has a Z-shaped contour. Due to such a design, the passive transfer element may also be referred to as a curved baffle, or be realized as a curved baffle. The ramp-shaped portion may have a gradient that changes over its length. In particular, those transition regions where the ramp-shaped portion borders on one of the other portions are provided with a gradient for a "soft" transition. A radius may be provided in the transition regions.

Advantageously, it may be provided that the device has a sliding means that can be coupled to the passive transfer element, the drive system being configured to generate a linear relative movement between the sliding means and the passive transfer element.

The sliding device is preferably realized so as to be movable independently of the passive transfer element. The sliding device may be moved at a speed that differs from the speed at which the passive transfer element is moved, although the sliding device or the passive transfer element may also remain stationary. Alternatively, it may be provided that the passive transfer element is arranged in a fixed position and the sliding device is realized so as to be movable, or vice versa.

Can be coupled means that the sliding device does not have to be permanently coupled to the passive transfer element, but can be coupled to the passive transfer element, for example only for transferring the containers.

In a preferred embodiment, the sliding means has a pin configured to transfer the containers, and has a roller attached to the pin and supported and guided on the passive transfer element, such that the pin can be moved by a contour of the passive transfer element.

The contour by which the pin can be moved is formed in particular by the end face of the transfer element described above and preferably by the ramp-shaped portion. The transfer is preferably effected when the roller is supported on the ramp-shaped portion and the pin moves in particular perpendicularly with respect to the first and/or second and/or third movement path.

By providing such a sliding means, frictional contact between the containers and the passive transfer element can be avoided.

In a preferred embodiment, a holding element, preferably realized as a clip element, for passively holding the containers, or a holding means, preferably realized as a suction and/or gripping device, for actively holding the containers, is provided on at least one of the first container receptacles and/or second container receptacles.

The holding element, or the holding means, makes it possible to secure the containers to the dispensing holder or the receiving holder by respectively passive or active holding before and/or after the transfer. Such securing serves in particular to prevent the containers from falling out of the dispensing holder and/or receiving holder if the passive transfer element or the respectively other of the dispensing holder and receiving holder is not arranged opposite the first container receptacle or second container receptacle.

The clip element preferably has an arcuate and flexible strip that partially encloses the container when the latter is arranged in the first container receptacle or second container receptacle. An insertion aid may be provided at the free end of the strip, such that the strip is bent away, in particular when a container is being transferred through it, in order to reach the respective second container receptacle.

The containers arranged in the dispensing holder and/or receiving holder may be sucked in and/or gripped by a suction and/or gripping means before or after a transfer. It may be provided that the container is sucked in and/or gripped during the transfer, such that the active holding can have a supporting effect during the transfer.

Alternatively, the first container receptacle and/or the second container receptacle may be of such a shape that the containers are passively secured therein. Conceivable in particular is a base guide that supports the container at its base from below.

Furthermore, a filling machine having a device according to the invention is to be described here.

It is to be noted that the particular advantages and design features described in connection with the device described above are also applicable and transferable to the filling machine described.

The filling machine is preferably provided for filling the containers with a pharmaceutical product, in particular a liquid, or a food product. To fill the containers, the filling machine has in particular a filling unit that may be provided at a filling station of the filling machine. In particular, the filling unit has a plurality of filling elements that are preferably arranged in a row next to each other with the second spacing, and that may be attached, for example, to a free end of a robot arm. The filling machine may be used to close the filled containers downstream of filling. A closure unit provided for this purpose has, in particular, a plurality of closure elements that are preferably arranged in a row next to each other with the second spacing, and that may be attached, for example, to a free end of a robot arm.

The device is used in the filling machine to bring containers stored in a packaging with a first spacing into the optimum second mutual spacing before filling them. Preferably, the containers are removed from the packaging in rows and inserted into the dispensing holder. For this purpose, the filling machine may have a manipulator that sucks, or grips, the containers, for example at their head.

The control unit of the device according to the invention may be a higher-level control unit of the filling machine, or at least be incorporated therein.

Alternatively or in addition to use in the filling machine, the device may be provided for pre- and/or post-processing, i.e. before and/or after processing in the filling machine. For example, the device can be used in a so-called "renester", in which filled and closed containers are reinserted into the packaging. It is also conceivable to use the device in other machines, or in other processes.

Also described here is a method for operating a device according to the invention, comprising the following steps:

a) linearly moving the receiving holder relative to the dispensing holder and the passive transfer element, or linearly moving the dispensing holder and the passive transfer element relative to the receiving holder, in order to bridge a difference between the first spacing and the second spacing and bring a first container receptacle into alignment with a second container receptacle,

b) linearly moving the receiving holder and the dispensing holder in a synchronous manner relative to the passive transfer element, or linearly moving the passive transfer element relative to the dispensing holder and the receiving holder, in order to effect the transfer of at least one container.

It is to be noted that the particular advantages and design features described in connection with the device described and the filling machine described above are also applicable and transferable to the described method.

Steps a) and b) may be repeated alternately, in particular until all containers have been transferred from the dispensing holder to the receiving holder.

Particularly advantageously, the receiving holder is moved at two speeds and the dispensing holder and the passive transfer element are each moved at only one speed, or the dispensing holder and the passive transfer element are each moved at two speeds and the receiving holder is moved at only one speed.

Due to the two speeds, as described above, the difference between the first spacing and the second spacing, for example, can be bridged at a greater speed than the speed during the transfer. In this way, a first container receptacle and a second container receptacle can be brought into alignment in a manner that is as time-efficient as possible, and the transfer can be performed as gently as possible for the containers.

### BRIEF DESCRIPTION OF THE DRAWINGS

The invention and the technical context of the invention are explained in greater detail below with reference to the figures. The figures show a preferred exemplary embodiment, to which the invention is not limited. It is to be noted that the figures and the proportions shown in the figures are merely schematic. In the figures, as examples and in schematic form:

FIG. 1: shows a perspective representation of the described device in a first embodiment variant;

FIG. 2: shows a top view of the device shown in FIG. 1, at a first time-point in a transfer;

FIG. 3: shows a top view of the device shown in FIG. 1, at a second time-point in the transfer;

FIG. 4: shows a perspective representation of the described device in a second embodiment variant;

FIG. 5: shows a perspective representation of the described device in a third embodiment variant; and

FIG. 6: shows a top view of the described device in a fourth embodiment variant.

### DETAILED DESCRIPTION

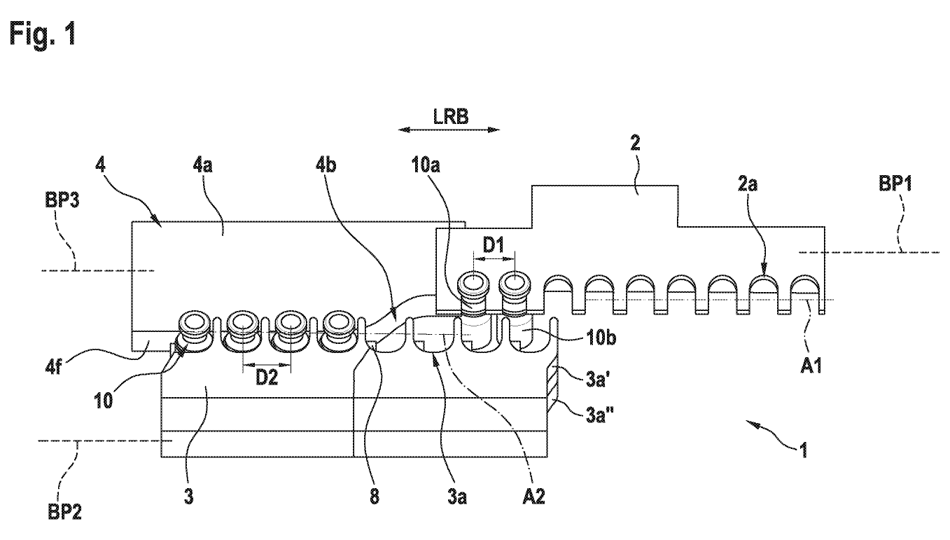

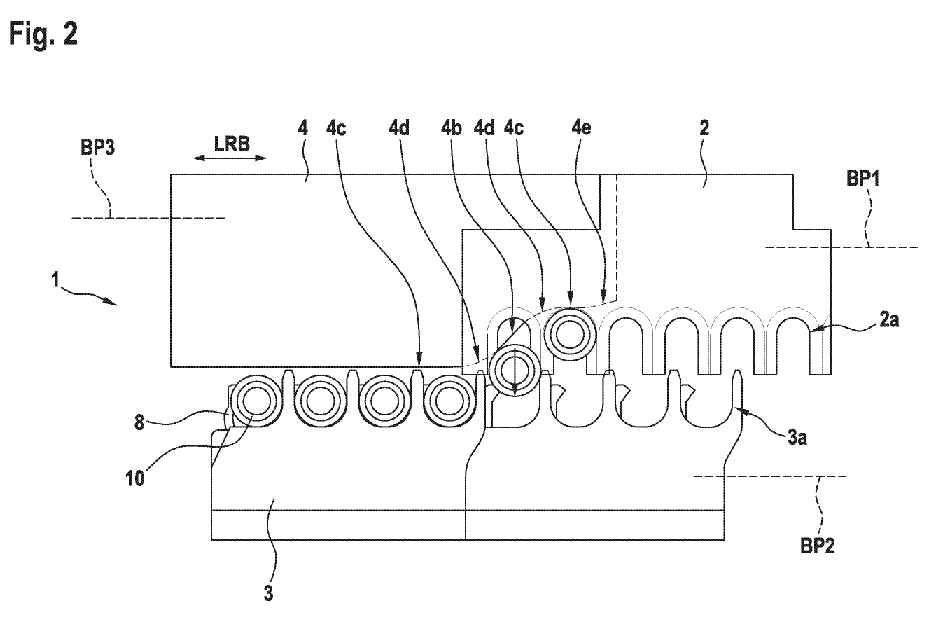

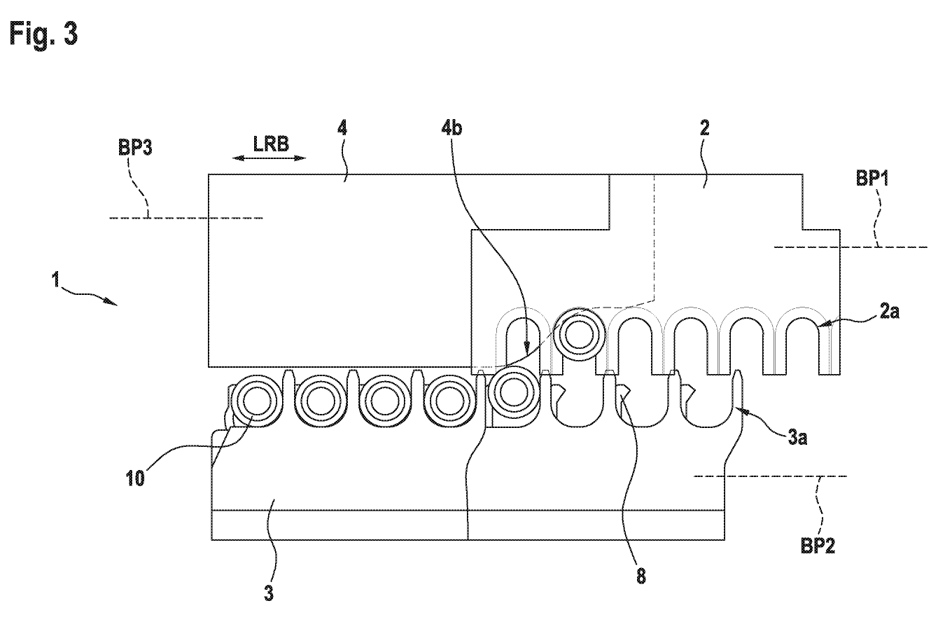

FIG. 1 shows a perspective representation of the described device 1 in a first embodiment. FIG. 2 shows a top view of the device 1 shown in FIG. 1 at a first time-point in a transfer. FIG. 3 shows a top view of the device 1 shown in FIG. 1 at a second time-point in the transfer.

In particular, the device 1 is arranged in a filling machine and serves to adjust a (separation) spacing between containers 10. The device 1 has a dispensing holder 2, a receiving holder 3 and a passive transfer element 4.

The dispensing holder 2 has a plurality of first container receptacles 2a, on which containers 10 can be held. The first container receptacles 2a are arranged in a regular row each with an invariable first mutual spacing D1, and each hold the container 10 at a container neck 10a. The first container receptacles 2a are U-shaped, resulting in a lateral opening via which the containers 10 can be dispensed during a transfer. The first container receptacles 2a are each realized in such a way that the containers 10 can be dispensed perpendicularly with respect to a first container axis A1 that extends along the first container receptacles 2a. The first container receptacles 2a have an offset 2b, such that the container 10 can be held by its container neck 10a without the container receptacle 2b colliding with a container body 10b.

The receiving holder 3 has a plurality of second container receptacles 3a, on which containers 10 can be held. The second container receptacles 3a are arranged in a regular row each with an invariable second mutual spacing D2, and hold the container 10 at a container body 10b. The second container receptacles 3a each have an upper part 3a' and a lower part 3a'', which hold the container body 10b at the top and bottom. The second container receptacles 3a are U-shaped, resulting in a lateral opening via which the containers 10 can be received during a transfer. The second container receptacles 3a are each realized in such a way that the containers 10 can be received perpendicularly with respect to a second container axis A2 that extends along the second container receptacles 3a. Attached to the second container receptacle 3a there is a respective optional holding element 8 is, by which the container 10 can be secured in the second container receptacle 3a.

The passive transfer element 4 has a body 4a, which has a ramp-shaped portion 4b on an end face 4f. The ramp-shaped portion 4b can effect the transfer of the containers 10 from the dispensing holder 2 to the receiving holder 3, i.e. from the first container receptacles 2a to the second container receptacles 3a. As can be seen in FIG. 2, the ramp-shaped portion 4b is located between two further portions 4c that are substantially parallel to each other. The end face 4f therefore has a Z-shaped contour. The ramp-shaped portion 4b has a gradient that changes over its length, with transition regions 4d at each of which the ramp-shaped portion 4b adjoins one of the other portions 4c. These transition regions 4d have a gradient for a "soft" transition. The passive transfer element 4 has a chamfer 4e, enabling a gentle "threading" into the contact between the container 10 and the passive transfer element 4.

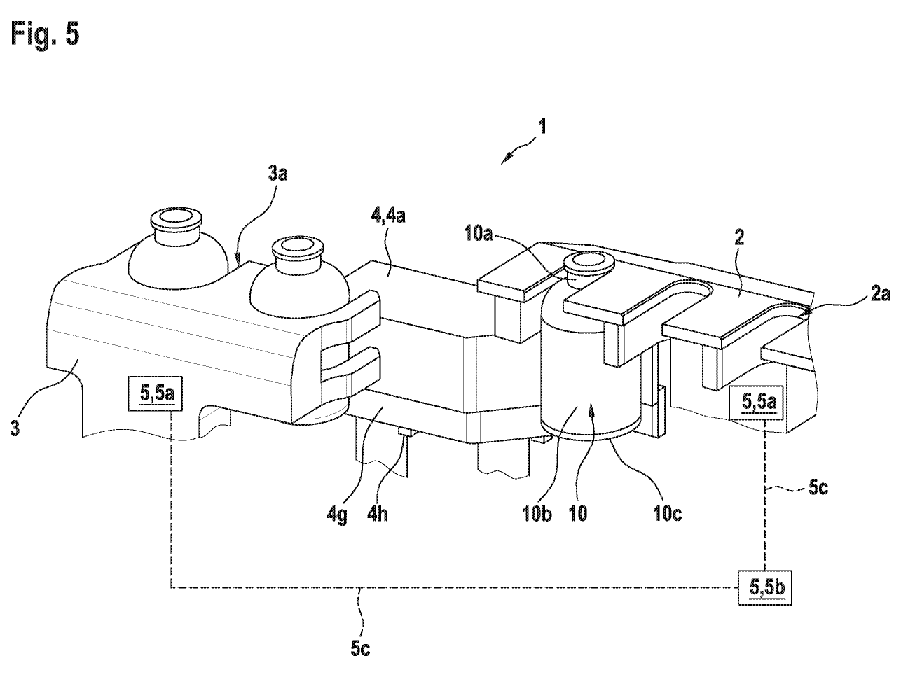

A drive system 5, not represented (see FIG. 5) of the device 1, is configured to generate a linear relative movement LRB between the dispensing holder 2, the receiving holder 3 and the passive transfer element 4.

The transfer of the foremost container 10 facing towards the passive transfer element 4 may be achieved in different ways. For example, the passive transfer element 4 may be arranged in a fixed position, and the dispensing holder 2 and the receiving holder 3 may be realized so as to move independently of each other. In particular, the dispensing holder 2 may then be moved relative to the passive transfer element 4 in order to dispense the containers 10 from the dispensing holder 2. The receiving holder 3 may then in particular be moved relative to the passive transfer element 4 in order to receive the containers 10 in the receiving holder 3 and thus enable the transfer. In particular, the receiving holder 3 may also be moved relative to the dispensing holder 2 in order to bridge a difference between the first spacing D1 and the second spacing D2, and to bring a first container receptacle 2a into alignment with a second container receptacle 3a.

Alternatively, the dispensing holder 2 or the receiving holder 3 may be arranged in a fixed position, and the passive transfer element 4 and the respectively other of the dispensing holder 2 and receiving holder 3 may be realized so as to move independently of each other. If the receiving holder 3 is arranged in a fixed position, the dispensing holder 2 may then be moved in particular relative to the receiving holder 3 in order to bridge the difference between the first spacing D1 and the second spacing D2 and to bring a first receiving position 2a and a second receiving position 3a into alignment. The passive transfer element 4 may then be moved in particular relative to the dispensing holder 2 in order to dispense the containers 10 from the dispensing holder 2. If the dispensing holder 2 is arranged in a fixed position, the receiving holder 3 may then be moved in particular relative to the dispensing holder 2 in order to bridge the difference between the first spacing D1 and the second spacing D2 and to bring a first receiving position 2a and a second receiving position 3a into alignment. The passive transfer element 4 may then be moved in particular relative to the dispensing holder 2 in order to dispense the containers 10 from the dispensing holder 2.

If the dispensing holder 2 is realized so as to be movable, it can be moved along a first movement path BP1, with the first movement path BP1 running substantially parallel to the second container axis A2. If the receiving holder 3 is realized so as to be movable, it can be moved along a second movement path BP2, the second movement path BP2 running substantially essentially parallel to the first container axis A1 and to the first movement path BP1. If the passive transfer element 4 is realized so as to be movable, it is movable along a third movement path BP3, with the third movement path BP3 running substantially parallel to the first container axis A1 and the second container axis A2, and parallel to the first movement path BP1 and the second movement path BP2.

For the transfer, the linear relative movement LRB first moves the passive transfer element 4 towards the dispensing holder 2, or the dispensing holder 2 towards the passive transfer element 4, until the foremost container 10 bears against the passive transfer element 4, or its ramp-shaped portion 4b. As a result of the passive transfer element 4 continuing to move relative to the dispensing holder 2, the container 10 is transferred.

At the time-point shown in FIG. 2, the foremost container 10 has already been partially dispensed from the first container receptacle 2a and has already been partially received by the second container receptacle 3a. At this time-point, the next container 10 has already come to bear against the passive transfer element 4.

At the time-point shown in FIG. 3, the transfer of the foremost container 10 is almost complete. At this time-point, the next container 10 is bearing against the ramp-shaped portion 4b of the passive transfer element 4.

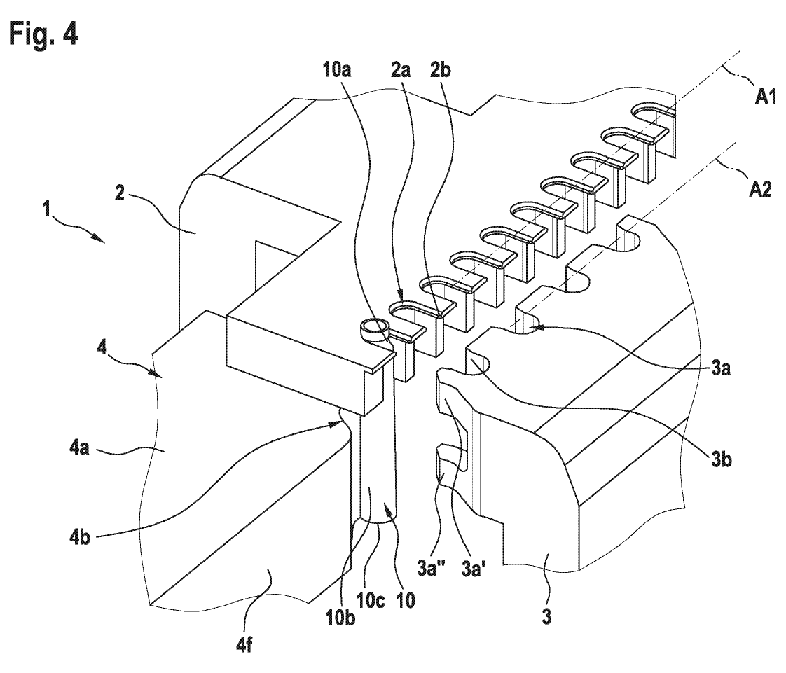

FIG. 4 shows a perspective representation of the described device 1 in a second embodiment. Compared to the first embodiment shown in FIGS. 1 to 3, the containers 10 have an elongate shape and are in particular carpules. In the second embodiment shown here, the passive transfer element 4 is thicker than in the first embodiment.

FIG. 5 shows a perspective representation of the described device 1 in a third embodiment.

In the third embodiment shown here, the passive transfer element 4 has a fastening structure 4g, to which the body 4a of the passive transfer element 4 is fastened by screws 4h. This means that the body 4a can be replaced and the device 1 can therefore be converted for other container types and/or sizes.

The device 1 additionally has a drive system 5 that is configured to generate a linear relative movement LRB between the dispensing holder 2, the receiving holder 3 and the passive transfer element 4. The drive system 5 in this case comprises two linear drives 5a and has a control unit 5b. The control unit 5b is connected to respectively one of the linear drives 5a via a signal connection 5c, such that the control unit 5b can control the linear drives 5a. In the present case, the dispensing holder 2 and the receiving holder 3 are each realized so as to be movable by means of the linear drive 5a. As described above, also conceivable are other embodiments in which, for example, the passive transfer element 4 is realized so as to be movable.

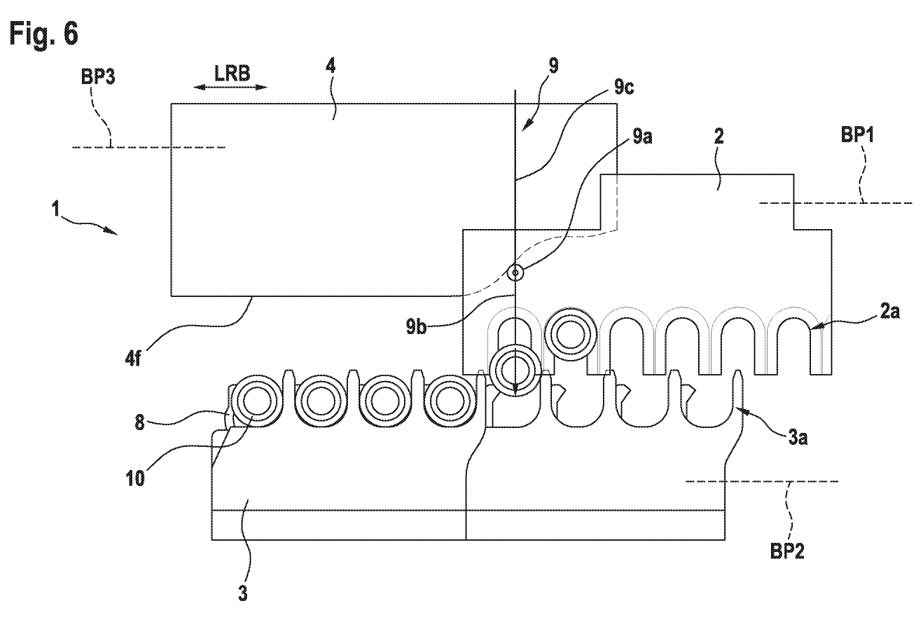

FIG. 6 shows a top view of the described device 1 in a fourth embodiment. In this fourth embodiment, the device 1 comprises a sliding means 9 that can be coupled to the passive transfer element 4. The sliding device 9 has a pin 9b configured to transfer the containers 10, and has a roller 9a attached to the pin 9b. The roller 9a is attached to a fastening structure 9c that can be moved linearly relative to the passive transfer element 4, in particular by means of a linear drive 5a of the drive system 5, or vice versa, whereby a linear relative movement LRB is generated between the sliding device 9 and the passive transfer element 4. The fastening structure 9c allows the roller 9a to move perpendicularly with respect to the first movement path BP1, second movement path BP2 and third movement path BP3.

The roller 9a is supported on the passive transfer element 4 and is guided on it. The pin 9b can thus be moved over a contour of the passive transfer element 4, formed by the end face 4f, in order to transfer the respective container 10. The transfer is effected when the roller 9a is supported, as represented, on the ramp-shaped portion 4b. The pin 9b then moves perpendicularly with respect to the first movement path BP1, second movement path BP2 and third movement path BP3 and with its free end pushes the container 10 from the first container receptacle 2a into the second container receptacle 3a.

### List of reference designations

1 device

2 dispensing holder

2a first container receptacle

2b offset

3 receiving holder

3a second container receptacle

3a' upper part

3a'' lower part

3b chamfer

4 passives transfer element

4a body

4b ramp-shaped portion

4c further portion

4d transition region

4e chamfer

4f end face

4g fastening structure

4h screw

5 drive system

5a linear drive

5b control unit

5c signal connection

8 holding element

9 sliding means

9a roller

9b pin

9c fastening structure

10 container

10a container neck

10b container body

10c container base

A1 first container axis

A2 second container axis

D1 first spacing

D2 second spacing

BP1 first movement path

BP2 second movement path

BP3 third movement path

LRB linear relative movement

1. A device (1) for adjusting a spacing between containers (10), having a dispensing holder (2) comprising at least two first container receptacles (2a) that are arranged with an invariable first mutual spacing (D1) and are each configured to hold one of the containers (10), further having a receiving holder (3) comprising at least two second container receptacles (3a) that are arranged with an invariable second mutual spacing (D2) that differs from the first spacing (D1) and are each configured to hold one of the containers (10), further having a passive transfer element (4), which is independent of the dispensing holder (2) and the receiving holder (3) and by which a transfer of the containers (10) from the first container receptacles (2a) to the second container receptacles (3a) can be effected, the device (1) having a drive system (5) that is configured to generate a linear relative movement between the dispensing holder (2), the receiving holder (3) and the passive transfer element (4).

2. The device (1) according to claim 1, configured such that, between the dispensing holder (2), the receiving holder (3) and the passive transfer element (4), at least two different linear relative movements can be generated along a first movement path (BP1) and a second movement path (BP2).

3. The device (1) according to claim 2, the first movement path (BP1) and the second movement path (BP2) being collinear.

4. The device (1) according to claim 1, the passive transfer element (4) being arranged in a fixed position, and the dispensing holder (2) and the receiving holder (3) being realized so as to be movable independently of each other.

5. The device (1) according to claim 4, the drive system (5) having a control unit (6) that is configured to control the dispensing holder (2) and the receiving holder (3) in such a way that they move at mutually differing speeds.

6. The device (1) according to claim 1, the dispensing holder (2) or the receiving holder (3) being arranged in a fixed position, and the passive transfer element (4), as well as the respectively other of the dispensing holder (2) and receiving holder (3), being realized so as to be movable independently of each other.

7. The device (1) according to claim 6, the drive system (5) having a control unit (6) that is configured to control the transfer element (4) and the dispensing holder (2), or the receiving holder (3) in such a way that they move at mutually differing speeds.

8. The device (1) according to claim 1, the passive transfer element (4) having a ramp-shaped portion (4b) by which the transfer of the containers (10) can be effected.

9. The device (1) according to claim 1, having a sliding means (9) that can be coupled to the passive transfer element (4), the drive system (5) being configured to generate a linear relative movement between the sliding means (9) and the passive transfer element (4).

10. The device (1) according to claim 9, the sliding means (9) having a pin (9b) configured to transfer the containers (10), and having a roller (9a) attached to the pin (9b) and supported and guided on the passive transfer element (4), such that the pin (9b) can be moved by a contour of the passive transfer element (4).

11. The device (1) according to claim 1, wherein a holding element (8) or a holding means for actively holding the containers (10) is provided on at least one of the first container receptacles (2a) and/or second container receptacles (3a).

12. A filling machine having a device (1) according to claim 1.

13. A method for operating a device (1) according to claim 1, comprising the following steps:
a) linearly moving the receiving holder (3) relative to the dispensing holder (2) and the passive transfer element (4), or linearly moving the dispensing holder (2) and the passive transfer element relative (4) to the receiving holder (3), in order to bridge a difference between the first spacing (D1) and the second spacing (D2) and bring a first container receptacle (2a) into alignment with a second container receptacle (3a),
b) linearly moving the receiving holder (3) and the dispensing holder (2) in a synchronous manner relative to the passive transfer element (4), or linearly moving the passive transfer element (4) relative to the dispensing holder (2) and the receiving holder (3), in order to effect the transfer of at least one container (10).

14. The method according to claim 13, the receiving holder (3) being moved at two speeds and the dispensing holder (2) and the passive transfer element (4) being each moved at only one speed, or the dispensing holder (2) and the passive transfer element (4) being each moved at two speeds and the receiving holder (3) being moved at only one speed.

15. The device (1) according to claim 1, wherein the containers are vials and/or carpules and/or syringes.

16. The device (1) according to claim 11, wherein the holding element (8) is a clip element for passively holding the containers (10).

17. The device (1) according to claim 11, wherein the holding means is a suction and/or gripping device.
